(19) United States
(12) Patent Application Publication
(10) Pub. No.: US 2005/0017644 A1
(43) Pub. Date: Jan. 27, 2005

(54) Discharge lamp

(75) Inventors: Tomio Ono, Kanagawa (JP); Naoshi Sakuma, Kanagawa (JP); Tadashi Sakai, Kanagawa (JP); Mariko Suzuki, Kanagawa (JP); Hiroaki Yoshida, Kanagawa (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/897,113

(22) Filed: Jul. 23, 2004

(30) Foreign Application Priority Data
Jul. 25, 2003 (JP) 2003-202124
Sep. 29, 2003 (JP) 2003-338566

(51) Int. Cl. H01J 17/04; H01J 17/20; H01J 61/04

(52) U.S. Cl. 313/633; 313/637; 313/491

(57) ABSTRACT

A discharge lamp, in which diamond high in secondary electron emission efficiency and low in sputtering ratio is used as a cold cathode, includes an outer envelope filled with a discharge gas, a fluorescent film provided on an inner surface of the outer envelope, and a pair of electrodes which cause discharge to occur within the outer envelope. A diamond member is provided on a surface of each electrode, and oxygen is contained in the discharge gas at a ratio not less than 0.002% and not more than 12.5%.

### CROSS-REFERENCE TO RELATED APPLICATIONS

This application is based upon and claims the benefit of priority from the prior Japanese Patent Applications No.2003-202124 filed on Jul. 25, 2003 and No. 2003-338566 filed on September 29, 2003 the entire contents of which are incorporated herein by reference.

### BACKGROUND OF THE INVENTION

1) Field of the Invention

The present invention relates to a discharge lamp used as an illuminator or a backlight of a liquid crystal display. More specifically, the present invention relates to a discharge lamp using hot cathodes or cold cathodes.

2) Description of the Related Art

Discharge lamps account for about a half of illumination light sources currently distributed, and the technology of discharge lamp is important to industries and life in general. A discharge lamp includes, as its basic structure, a discharge tube filled with rare gas and small amount of mercury and having an inner surface coated with a phosphor, and cathodes provided on both ends of the discharge tube to be opposed each other. When a voltage is applied between the cathodes, electrons are emitted from the cathodes and discharge occurs. The mercury atoms are given energy by the impact of electrons or excited rare gas atoms, and ultraviolet rays are thereby irradiated. The irradiated ultraviolet rays excite the phosphor to generate visible rays. An emission color, which is, for example, white, daylight color, or blue, varies according to a type of the phosphor.

Types of discharge lamps are typically classified as discharge lamps using hot cathodes and discharge lamps using cold cathodes. The hot cathode is composed of a coiled filament coated with an electron emitting substance called “emitter”. In the discharge lamp using the hot cathodes, temperatures of the filaments reach 1,000 degrees or more while the discharge lamp is discharging current,.so that the emitters coated on the filaments are partially evaporated. In addition, the emitters coated on the filaments are sputtered by collision of ions or collision of electrons, and consumed. As a result of the evaporation or sputtering, the emitters are diffused into the discharge tube. The diffused emitters adhere to an inner surface of the discharge tube, and react with mercury, thereby forming amalgam and being blackened. This phenomenon not only mars an appearance of the discharge lamp but also causes a reduction in the amount of emitted light of the discharge lamp.

As the discharge lamp intended to prevent consumption of the emitters, there is known, for example, a hot cathode discharge lamp using diamond particles for emitters (see Japanese Patent Application Laid-open No. H10-69868 and No. 2000-106130). Since diamond is high in electron emission efficiency and high in sputtering resistance, the discharge lamp that uses diamond particles is ensured of high light emission efficiency long life, accordingly. To coat or attach the diamond particles on each filament, an electrode material constituting the filament is immersed in a solution mixture of the diamond partides and an organic solvent, and subjected to ultrasonic cleaning, for example.

Further, by introducing a hydrogen gas into the discharge tube, the diamond particles are sputtered less frequently and the light emission efficiency of the discharge lamp is enhanced, accordingly. Nevertheless, the study of the inventor of the present invention reveals that even the discharge lamp using diamond for emitters inevitably faces deterioration in light emission efficiency when the lamp is used for a long time.

Meanwhile, a cold cathode discharge lamp is configured so that a pair of cold cathodes are arranged to be opposed each other within a discharge tube, and that a rare gas and a trace amount of mercury are filled into the discharge tube. A cold cathode discharge lamp called “a cold cathode discharge lamp” is configured so that electrodes are provided outside of a discharge tube. In other words, in the cold cathode discharge lamp, the cathodes are out of contact with a discharge surface.

The cold cathode discharge lamp is characteristically low in probability of breaking of the filaments, low in the consumption of the emitters, and quite long in life, as compared with the hot cathode discharge lamp. The cold cathode discharge lamp is, however, disadvantageously lower in light emission efficiency than the hot cathode discharge lamp. There is known a cold cathode discharge lamp using diamond particles for emitters so as to enhance the light emission efficiency (see Japanese Patent Application Laid-open No. 2002-298777 and No.2003-132850). However, similarly to the hot cathode discharge lamp, the study of the inventor of the present invention reveals that even the cold cathode discharge lamp using diamond for emitters inevitably faces deterioration in light emission efficiency when the lamp is used for a long time.

### SUMMARY OF THE INVENTION

It is an object of the present invention to at least solve the problems in the conventional technology.

A discharge lamp according to one aspect of the present invention includes an outer envelope filled with a discharge gas; a fluorescent film provided on an inner surface of the outer envelope; electrodes provided within the outer envelope, and causing electric discharge to occur within the outer envelope; and a diamond member provided on a surface of each of the electrodes. In the discharge lamp, oxygen is contained in the discharge gas at a ratio not less than 0.002% and not more than 12.5%.

A discharge lamp according to another aspect of the present invention includes an outer envelope filled with a discharge gas; a fluorescent film provided on an inner surface of the outer envelope; electrodes provided on an outer surface of the outer envelope, and causing electric discharge to occur within the outer envelope; and a diamond member provided on an inner surface of the outer envelope to be opposed to each of the electrodes. In the discharge lamp, oxygen is contained in the discharge gas at a ratio not less than 0.002% and not more than 12.5%.

A discharge lamp according to still another aspect of the present invention includes an outer envelope filled with a discharge gas; a fluorescent film provided on an inner surface of the outer envelope; electrodes provided within the outer envelope, and causing electric discharge to occur within the outer envelope; a diamond member provided on a surface of each of the electrodes; and a member containing a hydrogen absorbing alloy, and provided within the outer envelope.

A discharge lamp according to still another aspect of the present invention includes an outer envelope filled with a discharge gas; a fluorescent film provided on an inner surface of the outer envelope; electrodes provided on an outer surface of the outer envelope, and causing electric discharge to occur within the outer envelope; a diamond member provided on the inner surface of the outer envelope to be opposed to each of the electrodes; and a member containing a hydrogen absorbing alloy, and provided within the outer envelope.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-sectional view of a cold cathode discharge lamp having an oxygen gas filled into a discharge tube, according to a first embodiment of the present invention;

FIG. 2 is a characteristic chart of a relationship between a partial pressure of the oxygen gas filled into the discharge tube and a discharge starting voltage;

FIG. 3 is a schematic diagram of a microwave plasma chemical vapor deposition (CVD) system which forms a diamond film;

FIG. 4 is a cross-sectional view of an external electrode discharge lamp having an oxygen gas filled into a discharge tube according to a second embodiment of the present invention;

FIGS. 5A and 5B are cross-sectional views of a hot cathode discharge lamp having an oxygen gas filled into a discharge tube according to a third embodiment of the present invention;

FIGS. 6A and 6B are cross-sectional views of a hot cathode discharge lamp including a hydrogen absorbing alloy according to a fourth embodiment of the present invention;

FIG. 7 is a cross-sectional view of a hot cathode discharge lamp including a hydrogen absorbing alloy according to a fifth embodiment of the present invention;

FIG. 8 is a cross-sectional view of a cold cathode discharge lamp including a hydrogen absorbing alloy according to a sixth embodiment of the present invention;

FIG. 9 is a cross-sectional view of a cold cathode discharge lamp including a hydrogen absorbing alloy according to a seventh embodiment of the present invention;

FIG. 10 is an energy band diagram of diamond doped with an n-type dopant in a discharge lamp according to an eighth embodiment of the present invention;

FIG. 11 is a cross-sectional view of a cathode in a discharge lamp according to a ninth embodiment of the present invention;

FIG. 12 is a cross-sectional view of a cathode in a discharge lamp according to a tenth embodiment of the present invention; and

FIG. 13 is a cross-sectional view of an external electrode discharge lamp including a hydrogen absorbing alloy according to an eleventh embodiment of the present invention.

### DETAILED DESCRIPTION

Exemplary embodiments of the present invention will be explained in detail with reference to the accompanying drawings.

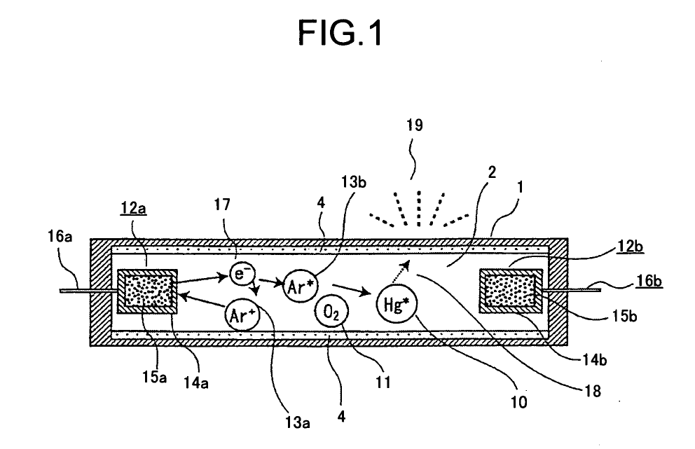

FIG. 1 is a cross-sectional view of a cold cathode discharge lamp having an oxygen gas filled into a discharge tube, according to a first embodiment of the present invention. As shown in FIG. 1, a pair of electrodes (cold cathodes) 12a and 12b are provided on both ends of an interior of a glass tube 1, respectively. The electrodes 12a and 12b are respectively composed of cathode supporting members 15a and 15b consisting of tungsten (W) of molybdenum (Mo), and diamond films 14a and 14b formed on surfaces of the cathode supporting members 15a and 15b. The cathode supporting members 15a and 15b are connected to an external power supply via lead wires 16a and 16b, respectively. A discharge gas is filled into the glass tube 1. A rare gas (e.g., Ar, Ne, or Xe) or a mixture rare gas of Ar, Ne, and Xe and a hydrogen gas are filled, as the discharge gas, into the glass tube 1 at a pressure of 60 hectopascals so as to facilitate discharge. A ratio of a partial pressure of the hydrogen gas to a total pressure is 1%. Further, a trace amount of mercury of afew milligrams is filled into the glass tube 1. According to the first embodiment, a trace amount of oxygen gas 11 is characteristically, further filled into the glass tube 1 at a partial pressure ratio of 1%.

In this discharge lamp, a high voltage of, for example, 500 volts is applied between the electrodes 12a and 12b via the lead wires 16a and 16b connected to the external power supply. Normally, an alternating-current voltage is applied between the electrodes 12a and 12b. When one of the electrodes 12a and 12b functions as an emitter (a cathode), the other electrode functions as an anode.

Before the voltage is applied, the interior of the glass tube 1 is in an insulated state. When the voltage is applied between the electrodes 12a and 12b, electrons remaining in the glass tube 1 are attracted toward the anode, quickly moved, and collided against atoms of the rare gas or mixture rare gas, thereby generating new electrons and new rare gas ions. By repeating the collision, ions 13a are multiplied, and the multiplied ions 13a are incident on the electrode (cathode) 12a (or 12b). As a result, secondary electrons 17 are emitted from the diamond film 14a (or 14b), thus starting discharge.

The secondary electrons 17 are also collided against atoms of the rare gas or mixture rare gas. The collided atoms are transformed to cations 13a and incident on the electrode (cathode) 12a (or 12b). The incidence of the ions 13a causes the secondary electrons 17 to be emitted again from the diamond film 14a (or 14b), thereby maintaining discharging current. A voltage necessary to maintain discharging the current (hereinafter, “discharge maintaining voltage”) is lower than a voltage necessary to start discharging the current (hereinafter, “discharge starting voltage”).

Since diamond high in secondary electron emission efficiency is used, the discharge starting voltage and the discharge maintaining voltage of the discharge lamp according to this embodiment are far lower than those of a conventional discharge lamp using a metal such as nickel (Ni) for cold cathodes. In addition, hydrogen contained in the discharge gas is terminated on the surfaces of the diamond films 14a and 14b. Therefore, the secondary electrons 17 can be emitted into a discharge space 2 with high efficiency, and the discharge starting voltage and the discharge maintaining voltage can be further reduced.

As a result of the discharge, the secondary electrons 17 are partially collided against mercury atoms 10 in the glass tube 1 and rare gas or mixture rare gas atoms 13b, thereby exciting the atoms 10 and 13b and causing the excited rare gas atoms 13b to be collided against the mercury atoms 10. The mercury atoms 10 are given energy by collision with the rare gas atoms 13b, and ultraviolet rays 18 are thereby emitted from the mercury atoms 10. The ultraviolet rays 18 excite a phosphor 4, whereby visible rays 19 having an emission color (e.g., white, daylight color, or blue) dependent on the phosphor 4 are radiated from the lamp.

By using the diamond films 14a and 14b as the emitters, the discharge starting voltage and the discharge maintaining voltage can be advantageously set low, and the discharge lamp low in power consumption can be advantageously provided. The discharge lamp according to the first embodiment exhibits not only these advantages but also the following advantages by containing the trace amount of oxygen gas 11 in the discharge gas.

When the ions 13a generated by ionizing atoms in the discharge gas are collided~against the surfaces (discharge surfaces) of the diamond films 14a and 14b, the secondary electrons 17 necessary to maintain the discharge are emitted and carbon atoms that constitute diamond are emitted as neutral atoms by sputtering. The emitted neutral atoms are collided against the atoms such as the rare gas atoms 13b and mercury atoms 10, and partially adhere again to the surfaces (discharge surfaces) of the diamond films 14a and 14b.

Graphite that is an isotope of diamond is lower in generation energy than diamond. For this reason, by readhesion of carbon, a thin layer mainly consisting of a graphite component or a thin layer consisting of amorphous carbon containing the graphite component is formed on the surface of each of the diamond films 14a and 14b.

This readhesion layer is low in secondary electron emission efficiency. This disadvantageously causes deterioration in electron emission efficiencies of the electrodes 12a and 12b and a reduction in the effect of high light emission efficiency attained by using diamond. In addition, when a state in which the discharge surface of each of the diamond films 14a and 14b is coated with the readhesion layer containing the non-diamond component continues, the cold cathode discharge lamp using diamond for the cathodes discharges current less frequently (to correspond to an increase in the discharge starting voltage), and the life of the discharge lamp is disadvantageously, considerably shortened.

The discharge lamp according to the first embodiment contains the trace amount of oxygen gas 11 in the discharge gas. Therefore, the readhesion layers can be selectively removed by the oxygen contained in the discharge gas. In oxygen-containing plasma, an etch rate of etching the non-diamond component such as graphite or amorphous carbon is higher than an etch rate of etching diamond. Therefore, the readhesion layers containing the non-diamond component can be selectively removed by the oxygen, relative to the diamond films 14a and 14b. Thus, the cold cathode discharge lamp which can maintain good secondary electron emission performances of the cathodes using diamond, and which can be ensured of a practically long life and high efficiency can be realized.

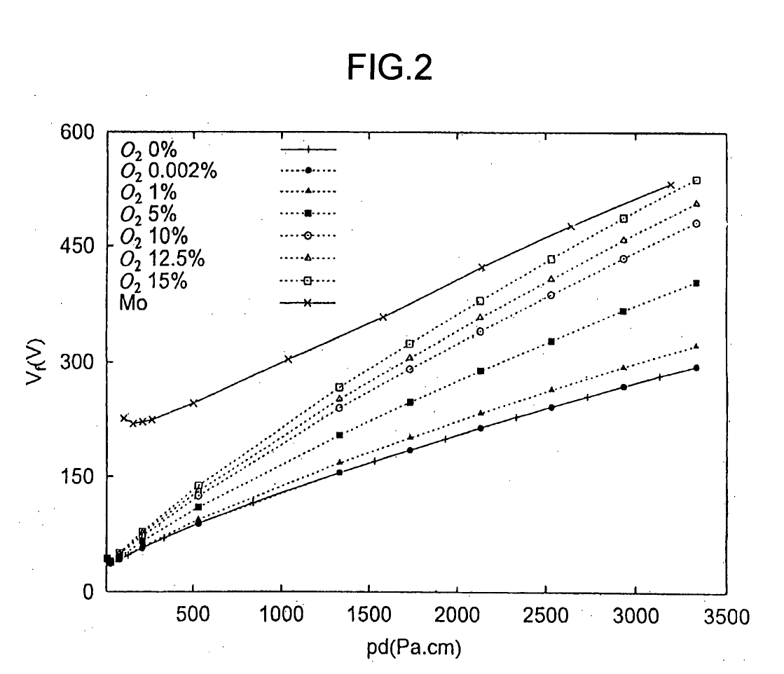

A preferable range of the partial pressure of the oxygen gas 11 filled into the glass tube 1 in the discharge lamp according to the first embodiment will next be explained. FIG. 2 is a characteristic chart of a relationship between the partial pressure of the oxygen gas 11 filled into the glass tube and the discharge starting voltage.

In FIG. 2, a horizontal axis indicates a product (p×d [Pa·cm]) between a total pressure (p [Pa]) of the interior of the glass tube 1 and a shortest distance (d [cm]) between the diamond films 14a and 14b. A vertical axis indicates the discharge starting voltage (V_{f}[V]). For comparison, a curve which indicates an instance of using a metal (Mo in this embodiment) in the cathodes is also shown. Normally, if the product p×d is greater, the discharge starting voltage V_{f} is higher. As shown in FIG. 2, if a ratio of the oxygen gas (the ratio of the partial pressure of the oxygen gas to the total pressure, in percent (%)) is higher, the discharge starting voltage V_{f} is higher. This is because, when the ratio of the oxygen gas which is difficult to ionize increases, it is difficult to discharge current. If the oxygen gas ratio is not more than 12.5%, the discharge starting voltage V_{f} is sufficiently lower than that of the metal. If the oxygen gas ratio exceeds 15%, however, the discharge starting voltage V_{f} is higher than that of the metal. Therefore, the ratio of the partial pressure of the oxygen gas is set not more than 12.5%, preferably not more than 10%, more preferably not more than 5%.

If the oxygen gas ratio is 0%, that is, no oxygen gas is contained in the discharge gas, the discharge starting voltage V_{f} is quite low. This discharge starting voltage V_{f} corresponds to a voltage when a discharge duration is zero, that is, the discharge lamp discharges current for the first time. If no oxygen gas is contained, then the discharge starting voltage V_{f} is higher as the discharge duration is longer, and the discharge lamp often cannot discharge the current. The following table of a relationship among the ratio of the oxygen gas (the ratio of the partial pressure of the oxygen gas to the total pressure, in %), the discharge duration time, and the discharge starting voltage V_{f}.

| | DISCHARGE DURATION | | | | |
|---|---|---|---|---|---|
| RATIO OF | 0 | 5,000 | 10,000 | 30,000 | 50,000 |
| OXYGEN GAS | HOUR | HOURS | HOURS | HOURS | HOURS |
| 0% | 295 V | 330 V | 373 V | 496 V | 504 V |
| 0.001% | 295 V | 317 V | 351 V | 425 V | 497 V |
| 0.0015% | 295 V | 308 V | 320 V | 388 V | 423 V |
| 0.002% | 296 V | 302 V | 311 V | 321 V | 344 V |
| 0.005% | 298 V | 302 V | 309 V | 316 V | 329 V |
| 1% | 323 V | 323 V | 325 V | 325 V | 327 V |

In the table, the discharge starting voltage V_{f} corresponds to a voltage when the discharge lamp starts discharging current if an alternating-current voltage is applied, and the discharge lamp starts and stops the discharge repeatedly in a half cycle. In the table, how the discharge starting voltage V_{f} changes according to a change in discharge duration is shown.

As shown in the table, if the oxygen gas ratio is 0%, that is, no oxygen gas is contained, then the discharge starting voltage V_{f} is higher as the discharge duration is longer, and the discharge lamp finally cannot discharge current. Likewise, f the oxygen gas ratio is 0.001% and 0.0015%, the discharge starting voltage V_{f} is higher as the discharge duration is longer, and the discharge lamp finally cannot discharge current. The reason is as follows. Since the oxygen gas is not present or hardly present, the formation of the readhesion layer containing the non-diamond component on the discharge surface of each of the diamond films 14a and 14b cannot be suppressed.

If the oxygen gas ratio is 0.002%, 0.005%, and 1%, the discharge starting voltage V_{f} does not increase or hardly increases. This is because the oxygen gas is sufficiently present, and can suppress the formation of the readhesion layer containing the non-diamond component on the discharge surface of each of the diamond films 14a and 14b. Therefore, the ratio of the partial pressure of the oxygen gas is set not less than 0.002%, preferably not less than 0.005%.

A method of manufacturing the discharge lamp according to the first embodiment will be explained. The cathode supporting members 15a and 15b each consisting of W or Mo are prepared, and the polycrystalline diamond films 14a and 14b each at a thickness of about 10 micrometers are formed on the surfaces of the cathode supporting members 15a and 15b, respectively. The diamond films 14a and 14b are doped with boron (B). The diamond films 14a and 14b are formed using a microwave plasma CVD method.

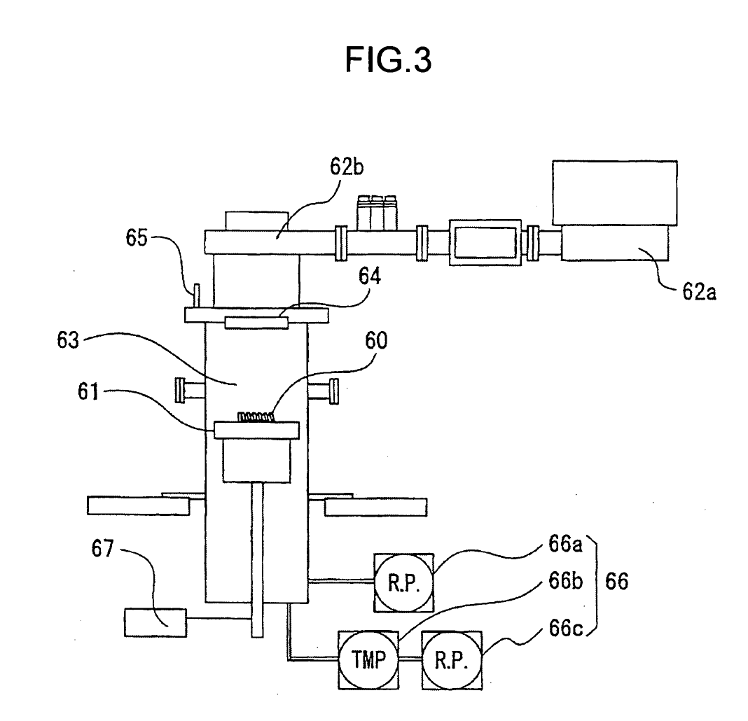

FIG. 3 is a cross-sectional view which depicts a configuration of a microwave plasma CVD system. As shown in FIG. 3, a microwave is introduced into a reaction chamber 63 from a microwave head 62a via a microwave waveguide 62b and a microwave introduction quartz window 64.

A reactive gas is introduced from a reactive gas inlet 65 into the reaction chamber 63. A sample 60 (the cathode supporting members 15a and 15b to which diamond seeds have been planted) is mounted on a heater stage 61. A vertical position of a supporting base for the heater stage 61 can be adjusted, and a mechanism which can adjusts the vertical position thereof to an optimum position is provided. A pressure of the reaction chamber 63 is regulated by a pressure regulation valve, not shown, and the air of the reaction chamber 63 is exhausted by a rotary pump. In addition, the reaction chamber 63 is evacuated by an exhausting system 66 composed of rotary pumps 66a and 66c and a turbo molecular pump 66b.

Boron oxide (B₂O₃) is dissolved in 2.68 cubic centimeters of methanol, and a resultant solution is mixed with 137 cubic centimeters of acetone, thereby generating a solution mixture. This solution mixture is supplied into the reaction chamber 63, in which the diamond films 14a and 14b are formed with hydrogen used as a carrier gas by microwave plasma CVD. Namely, the solution mixture serves as a carbon (diamond) source and a B (boron) source. Film formation conditions at this time are a substrate temperature of 850 degrees, an internal pressure of the reaction chamber 63 of 80 torrs, a flow rate of the carrier gas of 200 standard cubic centimeters per minute (sccm), a microwave power of 2 kilowatts, and a film formation time of 3 hours. Consequently, the electrodes 12a and 12b are completed, and the lead wires 16a and 16b are attached to the electrodes 12a and 12b, respectively.

The glass tube 1 coated with the phosphor 4 is prepared. As the phosphor 4, a calcium-halphosphate phosphor or the like can be used, and the slurried phosphor 4 may be coated on an inner surface of the glass tube 1. The electrodes 12a and 12b to which the lead wires 16a and 16b are attached are arranged on the both ends of the glass tube 1, respectively. The discharge gas is introduced into the glass tube 1, and the glass tube 1 is sealed with sealing parts provided on the both ends of the glass tube 1. For example, by heat-treating the sealing parts on the both ends of the glass tube 1 at a temperature of 800 degrees, the sealing parts are softened and fluidized, whereby the glass tube 1 can be sealed.

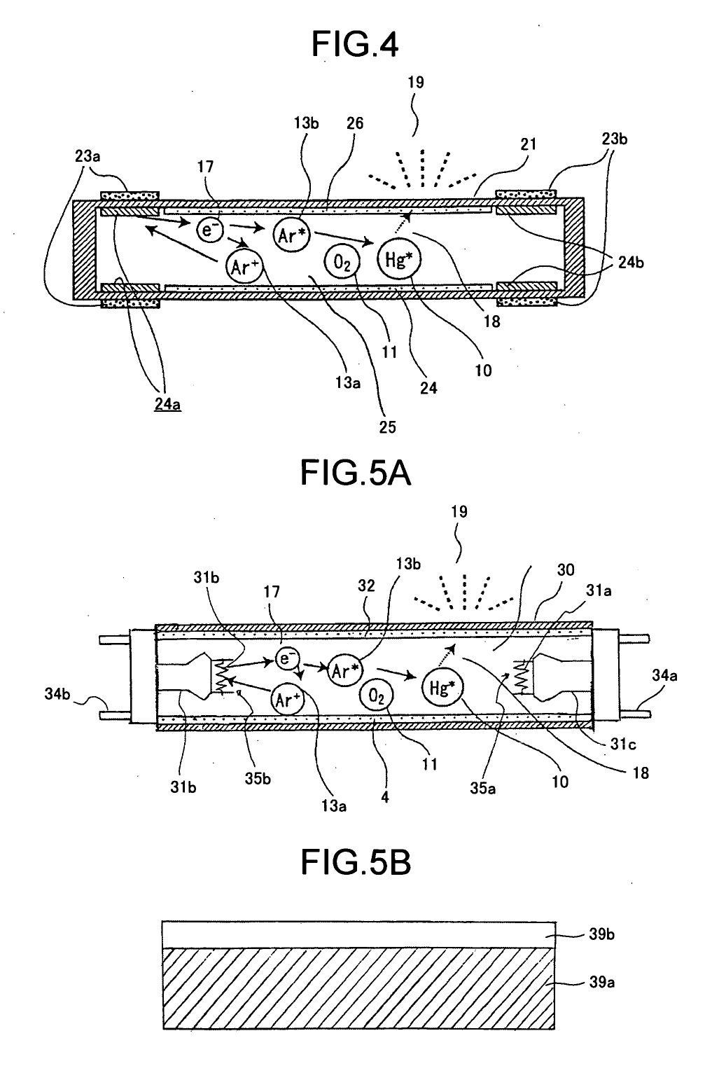

FIG. 4 is a cross-sectional view of an external electrode discharge lamp having the oxygen gas filled into a discharge tube according to a second embodiment of the present invention. Like constituent elements as those according to the first embodiment shown in FIG. 1 are designated by like reference signs, respectively. This discharge lamp is a so-called external electrode discharge lamp, which has electrodes provided outside of the discharge tube. By applying a voltage between the electrodes, discharge is induced within the discharge tube to thereby emit a light.

As shown in FIG. 4, the discharge lamp includes a glass tube 21, a phosphor 26, which is formed on an inner surface of the glass tube 21, and which generates a visible light when being irradiated with ultraviolet rays, pairs of cylindrical diamond layers 24a and 24b attached to inner surfaces of both ends of the glass tube 21, respectively, and pairs of external electrodes 23a and 23b attached to outer surfaces of the both ends of the glass tube 21 via the glass tube 21 relative to the paired diamond layers 24a and 24b, respectively. The paired external electrodes 23a and 23b consist of, for example, tungsten (W) or molybdenum (Mo).

A discharge gas is filled into an interior 25 of the glass tube 21 similarly to the first embodiment. Namely, a rare gas (e.g., Ar; Ne, or Xe) or a mixture rare gas of Ar, Ne, and Xe, a hydrogen gas, and a trace amount of mercury are filled, as the discharge gas, into the glass tube 21. In addition, a trace amount of an oxygen gas 11 is filled into the glass tube 21 with a ratio of a partial pressure of the oxygen gas 11 to a total pressure being 1%.

An operation of this external electrode discharge lamp will next be explained. To start discharge, a high-frequency voltage of 1,000 volts with a frequency of 40 kilohertz is applied between the paired external electrodes 23a and 23b. When one pair of the diamond layers 24a and 24b functions as an emitter (a cathode), the other pair functions as a counter (an anode). When this high-frequency voltage is applied between the electrodes 23a and 23b, electrons remaining in the glass tube 21 are attracted toward the anode, quickly moved, and collided against the rare gas or mixture rare gas atoms 13b, thereby generating new electrons and new rare gas ions. By repeating the collision, the ions 13a are multiplied, and the multiplied ions 13a are incident on the cathode 24a or 24b. As a result, the secondary electrons 17 are emitted from the paired diamond layers 24a (or 24b), thus starting discharge. Since hydrogen contained in the discharge gas are particularly terminated on surfaces of the diamond layers 24a and 24b, the secondary electrons 17 can be efficiently emitted into a discharge space 25.

With this mechanism, the discharge occurs intermittently similarly to the first embodiment, and the phosphor 26 is excited by ultraviolet rays 18 generated by the discharge to thereby generate visible rays 19. In the external electrode discharge lamp, the external electrodes 23a and 23b are not exposed to the discharge space 25. Therefore, it is unnecessary to cause mercury to be present in the glass tube 21 so as to suppress consumption of the external electrodes 23a and 23b. Therefore, only the hydrogen gas and the rare gas can be used as gas filled into the glass tube 21.

This external electrode discharge lamp uses diamond high in secondary electrode emission efficiency. Therefore, the discharge starting voltage of the external electrode discharge lamp is far lower than the discharge starting voltage of the conventional external electrode discharge lamp using a glass as an emitter. In addition, hydrogen contained in the discharge gas is terminated on the surfaces of the diamond layers 24a and 24b. The secondary electrons 17 can be thereby efficiently emitted into the discharge space 25, and the discharge starting voltage can be reduced.

Consequently, by employing the diamond layers 24a and 24b as electron emission sources, the discharge lamp which can start discharge at low voltage and which can be ensured of low power consumption can be provided. The discharge lamp according to the second embodiment can exhibit not only these advantages but also the same advantages as those of the first embodiment by containing the trace amount of oxygen gas 11 in the discharge gas.

Namely, by containing the trace amount of oxygen gas 11 in the discharge gas, the readhesion layers can be selectively removed by oxygen contained in the discharge gas. Therefore, diamond can be always exposed to the discharge surfaces. The external electrode discharge lamp which can maintain secondary electron emission performances of the cathodes using diamond, which can be ensured of a practically long life, and which has high efficiency can be realized, accordingly.

Similarly to the first embodiment, the partial pressure of the oxygen gas filled into the glass tube 21 in the discharge lamp is examined. As a result, the preferable range of the partial pressure of the oxygen gas is the same as that according to the first embodiment. The ratio of the partial pressure of the oxygen gas is set not less than 0.002%, preferably not less than 0.005%, and set equal to less than 12.5%, preferably not more than 10%, more preferably not more than 5%.

A method of manufacturing the discharge lamp according to the second embodiment will be explained. By using a mask or the like, the paired diamond layers 24a and 24b are formed only on inner surfaces of the both ends of the glass tube 21, respectively, and the phosphor 26 is coated and formed on the inner surface of the glass tube 21. In the formation of the paired diamond layers 24a and 24b, conductivity is unnecessary. Therefore, the forming method is the same as that according to the first embodiment except that a boric acid (B₂O₃) is not added. In addition, the material and forming method of the phosphor 26 are the same as those according to the first embodiment. The phosphor 26 is not formed on the inner surfaces of the both ends of the glass tube 21 on which the diamond layers 24a and 24b are provided, by using the mask or the like.

The discharge gas is introduced into the glass tube 21, and the glass tube 21 is sealed with sealing parts provided on the both ends of the glass tube 21. For example, by heat-treating the sealing parts on the both ends of the glass tube 21 at a temperature of 800 degrees, the sealing parts are softened and fluidized, whereby the glass tube 21 can be sealed. Finally, the external electrodes 23a and 23b are formed on both ends of outer surfaces of the glass tube 21, respectively. The discharge lamp according to the second embodiment is thus completed.

FIGS. 5A and 5B are cross-sectional views of a hot cathode discharge lamp according to the third embodiment of the present invention. Like constituent elements as those according to the first embodiment shown in FIG. 1 are designated by like reference signs, respectively. The discharge lamp according to this embodiment is a discharge lamp using hot cathodes, and includes a glass tube 30, electrodes 35a and 35b, electrode members 31a and 31b, lead wires 31c and 31d, and fittings 34a and 34b. The glass tube 30 is transparent, long, and narrow, and has a phosphor 32 (e.g., a calcium-halphosphate phosphor) coated on an inner surface. The electrodes 24a and 24b are attached to both ends of the glass tube 30, respectively. The lead wire 31c supports the electrode member 31a, and electrically connects the fittings 34a provided outside of the discharge lamp to the electrode member 31a. Likewise, the lead wire 31d supports the electrode member 31b, and electrically connects the fittings 34b provided outside of the discharge lamp to the electrode member 31b. As shown in FIG. 5B, each of the electrode members 31a and 31b is made of a double or triple coiled filament 39a (e.g., tungsten). An emitter 39b is coated on the filament 39a. The emitter 39b consists of monocrystalline or polycrystalline diamond.

A discharge gas is filled into the glass tube 30 so as to facilitate discharging current. The discharge gas consists of a rare gas (e.g., Ar, Ne, or Xe) or a mixture rare gas of Ar, Ne, and Xe, a trace amount of mercury, and a hydrogen gas, and a trace amount of the oxygen gas 11 is also filled into the glass tube 30 with a ratio of a partial pressure of the oxygen gas 11 to a total pressure being 1%.

When a current is applied between the electrode members 31a and 31b to perform preheating, electrons are emitted from the emitter 39a. The emitted electrons are moved to the counter electrode (the anode), whereby discharge starts. Normally, an alternating-current voltage is applied between the electrode members 31a and 31b so as to start discharge. If so, the electrode members 31a and 31 b alternately function as the emitter and the counter electrode (anode). This discharge causes the electrons to be collided against mercury atoms 10 filled into the glass tube 30, or collided against the atoms of the rare gas or mixture rare gas, thereby generating new electrons and new rare gas ions. The new electrons and rare gas ions are also collided against the mercury atoms 10. By the collisions, the mercury atoms 10 are given energy and the ultraviolet rays 18 are emitted. The ultraviolet rays 18 excite the phosphor 32, whereby the visible rays 19 having an emission color (e.g., white, daylight color, or blue) dependent on the phosphor 32 are radiated from the lamp.

A method of manufacturing the hot cathodes used in the hot cathode discharge lamp according to the third embodiment will be explained. A diamond seeds planting onto a surface of the coiled filament 39a will first be explained.

Diamond particles are mixed with an organic solvent, e.g., alcohol, and the resultant solvent is coated on the surface of the filament 39a. A particle diameter of the diamond particles mixed with the organic solvent is more than 0.1 micrometer and less than 1 micrometer. To coat the solvent, the filament 39a is immersed in the organic solvent mixed with the diamond particles, and subjected to ultrasonic cleaning. A treatment time for the ultrasonic cleaning is set at 30 minutes. By performing the ultrasonic cleaning, the diamond particles uniformly adhere to the surface of the filament 39a. Thereafter, the filament 39a is heated at a temperature of 200 degrees for 60 minutes in, for example, a nitrogen atmosphere, thereby removing the organic solvent and impurities if necessary.

The filament 39a which has been subjected to the diamond seeds planting is disposed in the microwave plasma CVD system as shown in FIG. 3, in which a diamond member is formed on a surface of a coiled electrode of the filament 39a.

As explained so far, the hot cathode discharge lamp according to the third embodiment can exhibit the same advantages as those of the first embodiment since the trace amount of oxygen gas 11 is contained in the discharge gas.

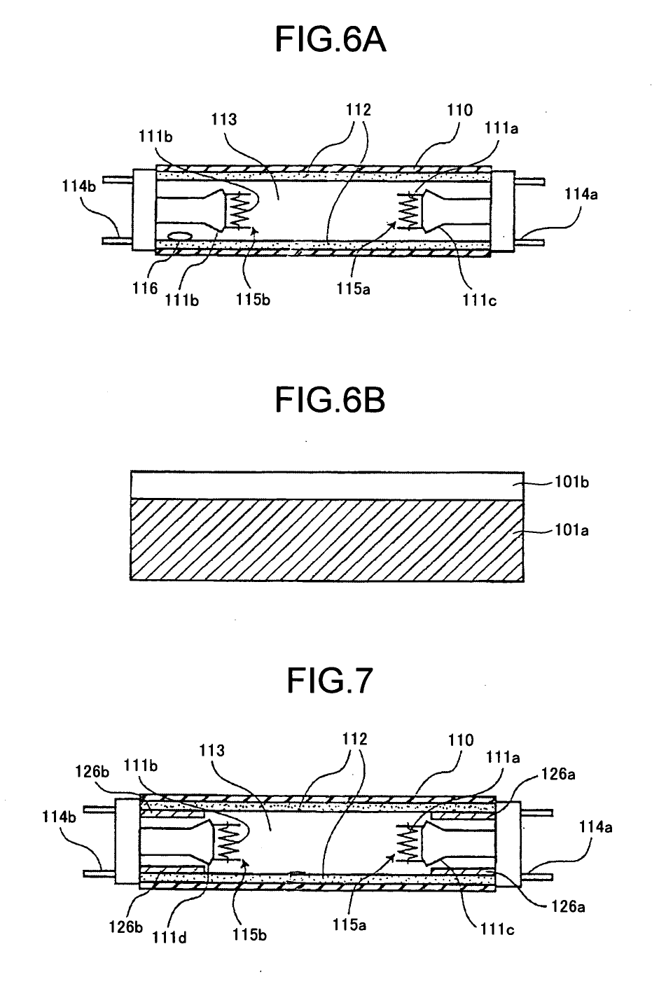

FIGS. 6A and 6B are cross-sectional views of a discharge lamp according to a fourth embodiment of the present invention. As shown in FIG. 6A, this discharge lamp employs hot cathodes, and includes a glass tube 110, electrodes 115a and 115b, electrode members 111a and 111b, lead wires 111c and 111d, and fittings 114a and 114b. The glass tube 110 is transparent, long, and narrow, and has a phosphor 112 (e.g., a calcium-halphosphate phosphor) coated on an inner surface. The electrodes 115a and 115b are attached to both ends of the glass tube 110, respectively. The lead wire 111c supports the electrode member 111a, and electrically connects the fittings 114a provided outside of the discharge lamp to the electrode member 111a. Likewise, the lead wire 111d supports the electrode member 111b, and electrically connects the fittings 114b provided outside of the discharge lamp to the electrode member 111b. As shown in FIG. 6B, each of the electrode members 111a and 111b is made of a double or triple coiled filament 101a (e.g., tungsten). A diamond thin film (an emitter) 101b that consists of monocrystalline or polycrystalline diamond is coated on the filament 101a.

A discharge gas 113 is filled into the glass tube 110 so as to facilitate discharging current. The discharge gas 113 consists of a rare gas (e.g., Ar; Ne, or Xe) or a mixture rare gas of Ar, Ne, and Xe, a trace amount of mercury, and a hydrogen gas. The rare gas and the mercury are filled into the glass tube 110 at a pressure of about 700 pascals, and the hydrogen gas is filled thereinto at a partial pressure of about 7 pascals. Further, a hydrogen absorbing alloy member 116 consisting of a hydrogen absorbing alloy, e.g., a magnesium-based CeMg₂ alloy is provided in the glass tube 110 so as to maintain the partial pressure of the hydrogen gas in the glass tube 110. This hydrogen absorbing alloy member 116 is pelletal, and fused with an inner wall of the glass tube 110 by glass frit.

When a current is applied between the electrode members 111a and 111b to perform preheating, electrons are emitted from the hot diamond thin film 101b. The emitted electrons are moved to the counter electrode (the anode), whereby discharge starts. Normally, an alternating-current voltage is applied between the electrode members 111a and 111b so as to start discharge. If so, the electrode members 111a and 111b alternately function as the emitter and the counter electrode (anode). This discharge causes the electrons to be collided against mercury atoms filled into the glass tube 110, or collided against the atoms of the rare gas or mixture rare gas, thereby generating new electrons and new rare gas ions. The new electrons and rare gas ions are also collided against the mercury atoms. By the collisions, the mercury atoms are given energy and the ultraviolet rays are emitted from the mercury atoms. The ultraviolet rays excite the phosphor 112, whereby visible rays having an emission color (e.g., white, daylight color, or blue) dependent on the phosphor 112 are radiated from the lamp.

The hot cathodes used in the hot cathode discharge lamp according to the fourth embodiment are manufactured by the same method as that explained in the third embodiment. According to this embodiment, diamond thin film formation conditions are as follows. A microwave power is 4 kilowatts, a reactive gas pressure is 13.3 kilopascals, a hydrogen gas flow rate is 400 sccm, a methane gas flow rate is 8 sccm, a methane concentration of a material gas is 2%, a film formation temperature is 850 degrees, and a film formation time is 120 minutes. Under these conditions, the polycrystalline diamond thin film 101b at a thickness of 5 micrometers is formed on a surface of the filament 101a. According to this embodiment, only the hydrogen gas and the methane gas are used to form the diamond thin film 101b. Alternatively, the diamond thin film 101b may be formed by doping an n-type dopant such as phosphorus, nitrogen, or sulfur, or a p-type dopant such as boron as impurities. The n-type dopant will be explained later in detail. A method of forming the diamond thin film 101b is not limited to the microwave plasma CVD Method. The diamond thin film 101b can be formed by, for example, electron cyclotron resonance CVD (ECRCVD) method or radio frequency CVD method.

A function of the hydrogen absorbing alloy will be explained. If diamond is formed by CVD using a hydrogen-containing gas as a carrier gas, hydrogen molecules are normally terminated on a surface of the diamond thin film 101b. This hydrogen terminated layer has a great effect on diamond characteristics, and plays an important role for indicating a negative electron affinity (NEA) characteristic. This NEA characteristic enables hot electrons to be emitted from the diamond at low temperature.

However, according to a study of the inventor of the present invention, after passage of a certain time, the partial pressure of the hydrogen gas within the glass tube is reduced for various reasons. In addition, an electron emission efficiency of the diamond (emitter) is deteriorated when the lamp is used for a long time, resulting in deterioration in a discharge efficiency of the lamp. The reasons for reducing the partial pressure of the hydrogen gas are considered to include, for example, leakage of the hydrogen gas within the tube from defective parts such as gaps and cracks of the glass tube and the electrode members.

According to the fourth embodiment, the hydrogen absorbing alloy member 116 is provided in the glass tube 110. Therefore, if the partial pressure of the hydrogen gas within the glass tube 110 is reduced as explained, then hydrogen is dissociated from the hydrogen absorbing alloy member 116 and emitted into the tube 110. The partial pressure of the hydrogen gas within the glass tube 110 can be thereby maintained at optimum level.

More specifically, when discharge occurs, an internal temperature of the glass tube 110 rises. The internal temperature of the glass tube 110 largely relates to excitation of mercury, and an optimum temperature is present by a sealing pressure of the discharge gas such as hydrogen. The internal temperature of the glass tube 110 is normally kept at about 80 degrees. The internal temperature, however, varies according to an application of the discharge lamp. In an experimental example according to the fourth embodiment, the internal temperature of the glass tube 110 is 80 degrees. A hydrogen dissociation pressure of the CeMg₂ alloy is quite low at a room temperature. However, following rise of the internal temperature of the glass tube 110, the hydrogen dissociation pressure gradually rises and reaches about 7 pascals at 80 degrees. Namely, the partial pressure of the hydrogen gas within the glass tube 110 of the discharge lamp is kept at 7 pascals. In this state, even if an amount of hydrogen gas is reduced in the glass tube 110, hydrogen is emitted from the hydrogen absorbing alloy member 116 so as to maintain the dissociation pressure.

FIG. 7 is a cross-sectional view of a discharge lamp according to a fifth embodiment of the present invention. Like constituent elements as those shown in FIG. 6A are designated by like reference signs, respectively. The discharge lamp according to the fifth embodiment is a discharge lamp using hot cathodes similarly to the fourth embodiment, but differs from the discharge lamp according to the fourth embodiment in that hydrogen absorbing alloy films 126a and 126b consisting of hydrogen absorbing alloys, e.g., magnesium-based CeMg₂ alloys are provided on the inner surface of the glass tube 110. The hydrogen absorbing alloy films 126a and 126b are provided around the paired electrodes 116a and 115b, respectively. The hydrogen absorbing alloy films 126a and 126b can be formed by performing oblique sputtering at a reduced pressure (e.g., about 5 pascals) using a sputtering target such as CeMg₂ alloys including argon, or by performing oblique evaporation with a material of the CeMg₂ alloys put at a reduced pressure (e.g., about 10⁻⁶ pascal).

A temperature of a discharge region between the electrode members 111a and 111b within the glass tube 110 is quite high. It is, therefore, preferable to provide the hydrogen absorbing alloy films 126a and 126b at positions near ends of the glass tube 110 relative to the electrode members 111a and 111b, respectively. Alternatively, the hydrogen absorbing alloy members 126a and 126b may be put closer to a center of the glass tube 110, according to the temperature and a position of the discharge region.

According to the fifth embodiment, the hydrogen absorbing alloy films 126a and 126b enable the partial pressure of the hydrogen gas within the glass tube 110 to be kept at appropriate level similarly to the fourth embodiment. According to this embodiment, in particular, since the hydrogen absorbing alloys are formed as the hydrogen absorbing alloy films 126a and 126b, a temperature distribution of the surface of the discharge lamp is uniform. It is thereby possible to uniformly emit hydrogen, obtain a uniform hydrogen partial pressure distribution, and stabilize discharge characteristics of the discharge lamp.

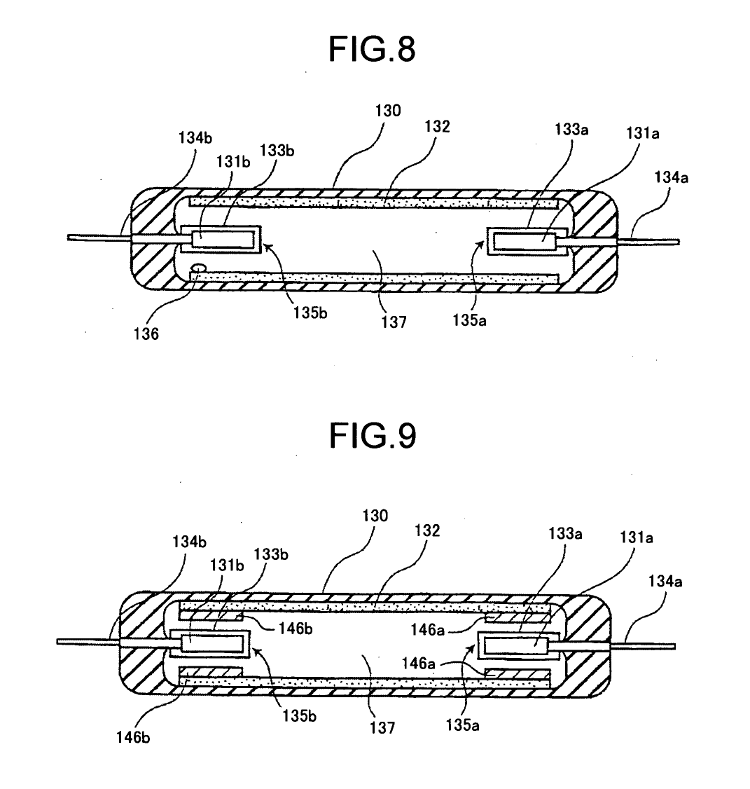

FIG. 8 is a cross-sectional view of a discharge lamp according to a sixth embodiment of the present invention. The discharge lamp according to this embodiment is a discharge lamp using cold cathodes. The discharge lamp includes a transparent, long, and narrow glass tube 130, and lead wires 134a and 134b inserted into the glass tube 130 from both ends of the glass tube 130 and filled with glass, respectively. A phosphor 132 consisting of the same material as that of the phosphor 112 according to the fourth embodiment is coated on the glass tube 130. Cathode supporting members 131a and 131b consisting of a metal such as nickel are provided in portions of the lead wires 134a and 134b protruding inward of the glass tube 130, respectively. Diamond thin films 133a and 133b serving as emitters are formed on surfaces of the cathode supporting members 131a and 131b, respectively. The diamond thin films 133a and 133b and the cathode supporting members 131a and 131b constitute electrodes (cathodes) 135a and 135b, respectively.

A discharge gas 137 is filled into the glass tube 130 so as to facilitate discharging current. The discharge gas 137 consists of a rare gas (e.g., Ar, Ne, or Xe) or a mixture rare gas of Ar, Ne, and Xe, a trace amount of mercury, and a hydrogen gas. The rare gas and the mercury are filled into the glass tube 130 at a pressure of about 3.5 kilopascals, and the hydrogen gas is filled thereinto at a partial pressure of about 35 pascals. Further, a hydrogen absorbing alloy member 116 consisting of a hydrogen absorbing alloy, e.g., an Mg₂Ni alloy is provided in the glass tube 130 so as to maintain the partial pressure of the hydrogen gas in the glass tube 130. This hydrogen absorbing alloy member 136 is pelletal, and fused with an inner wall of the glass tube 130 by glass frit.

The lead wires 134a and 134b protruding outward of the glass tube 130 are connected to, for example, an alternating-current power supply. When a current is applied between the lead wires 134a and 134b, strong electric fields are generated on surfaces of the diamond thin films 133a and 133b. The electric fields cause residual electrodes to be quickly moved, and emitted from the surfaces of the diamond thin films 133a and 133b. Further, while being attracted toward the counter electrode and quickly moved, the residual electrodes are collided against the rare gas or mixture rare gas. Cations multiplied by the collision are collided against the cathode, and secondary electrons are emitted from the cathode, thus starting discharge. The electrons and ions flowing by the discharge are collided against mercury atoms. By these collisions, the mercury atoms are given energy, and ultraviolet rays are emitted from the mercury atoms, accordingly. The ultraviolet rays excite the phosphor 132, whereby visible rays having an emission color (e.g., white, daylight color, or blue) dependent on the phosphor 132 are radiated from the lamp.

According to this sixth embodiment, similarly to the fourth embodiment, the hydrogen absorbing alloy member 136 consisting of the hydrogen absorbing alloy, e.g., the Mg₂Ni alloy is provided within the glass tube 130. Therefore, the sixth embodiment exhibits the same advantages as those of the fourth embodiment.

A method of manufacturing the electrodes 135a and 135b will be explained. The cathode supporting members 131a and 131b consisting of molybdenum are prepared, and a diamond seeds planting is performed on the surfaces of the cathode supporting members 131a and 131b similarly to the first embodiment. Thereafter, the cathode supporting members 131a and 131b which have been subjected to the diamond seeds planting are moved into the microwave plasma CVD system shown in FIG. 3, in which the diamond thin films 133a and 133b are formed on the surfaces of the cathode supporting members 131a and 131b, respectively. Diamond thin film formation conditions are as follows. A microwave power is 4 kilowatts, a reactive gas pressure is 15 kilopascals, a hydrogen gas flow rate is 300 sccm, a methane gas flow rate is 6 sccm, a methane concentration of a material gas is 2%, a film formation temperature is 800 degrees, and a film formation time is 120 minutes. Under these conditions, the polycrystalline diamond thin films 133a and 133b each at a thickness of 4 micrometers are formed.

According to this embodiment, only the hydrogen gas and the methane gas are used to form the diamond thin films 133a and 133b. Alternatively, the diamond thin films 133a and 133b may be formed by doping impurities. A method of forming the diamond thin films 133a and 133b may be the ECRCVD method or the radio frequency CVD method instead of the microwave plasma CVD Method.

FIG. 9 is a cross-sectional view of a discharge lamp according to a seventh embodiment of the present invention. Like constituent elements as those shown in FIG. 8 are designated by like reference signs, respectively. The discharge lamp according to the seventh embodiment is a discharge lamp using cold cathodes similarly to the sixth embodiment, but differs from the discharge lamp according to the sixth embodiment in that hydrogen absorbing alloy films 146a and 146b consisting of hydrogen absorbing alloys, e.g., Mg₂Ni alloys are provided on the inner surface of the glass tube 130. The arrangement of the hydrogen absorbing alloy films 146a and 146b and the advantages attained by the use of the hydrogen absorbing alloy films 146a and 146b are the same as those according to the fifth embodiment.

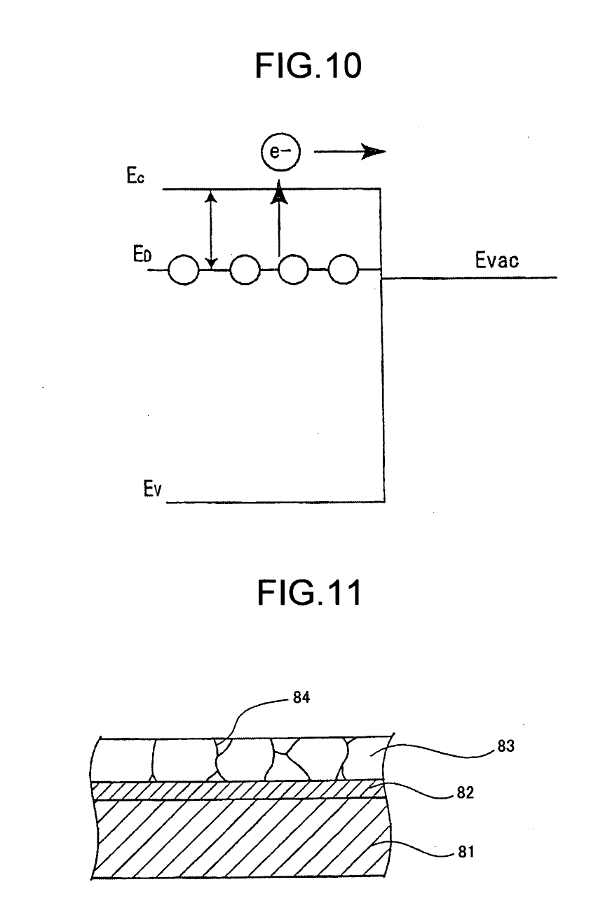

As an eighth embodiment of the present invention, an example of doping the diamond thin film with the n-type dopant will be explained. FIG. 10 is an energy band diagram which explains the principle of the eighth embodiment, and which depicts diamond doped with the n-type dopant. It is known that diamond has NEA. Namely, a bottom of a conduction band (Ec) of diamond is present at a lower position than a vacuum level (Evac). Electron affinity is energy necessary to move electrons present at the bottom of the conduction band into a vacuum. If the electron affinity is negative, this means that electrons have an increased tendency to be emitted.

However, a resistance of the n-type diamond is quite high at a room temperature. This is because an energy difference (Ed) between a level of a donor that gives electrons and the bottom of the conduction band (Ec) is about ten times as large as that for an ordinary semiconductor such as silicon (Si), and electrons are hardly present in the conduction band at the room temperature.

It is discovered that if the n-type diamond is employed as the emitters, a discharge lamp exhibits sufficiently excellent electron emission characteristics. In the eighth embodiment, a discharge lamp which exhibits excellent light emitting characteristics by employing the n-type diamond as the emitters will be explained.

When the n-type diamond is heated, electrons rise to the conduction band and the electrons can be emitted using the NEA characteristics. Namely, in the diamond having the NEA characteristics, a barrier that can prevent the electrons present in the conduction band from being emitted into the vacuum is not present. Eventually, therefore, energy necessary to emit the electrons is of the order of the above Ed. In the ordinary emitter which does not exhibit NEA characteristics, the vacuum level (Evac) is at a higher position than the bottom of the conduction band (Ec), and energy necessary to emit the electrons into the vacuum is near a work function. The energy difference (Ed) is about 0.6 electron volt when the diamond is doped with phosphorus. The work function is about 1.1 electron volts for BaO that is often used in a hot electron emission emitter. Since the Ed or the work function has an exponential influence on the hot electron emission, the n-type diamond can emit hot electrons at a low temperature. Accordingly, uniform hot electron emission at a low temperature can be realized in the discharge lamp, such as a fluorescent lamp, using the n-type diamond as hot cathodes. Thus, the hot cathode discharge lamp which is excellent in light emitting characteristics and which is ensured of a long life can be provided.

Further, the work function is quite sensitive to the influence of a surface state, and greatly influenced by a manufacturing process, atmosphere, and the like. Therefore, uniform hot electron emission in an electron emission surface is difficult to expect in the discharge lamp using the ordinary emitters that do not exhibit the NEA characteristics. Since the work function has an exponential influence on the hot electron emission, non-uniformity of the hot electron emission in the hot electron emission surface tends to be increased. In the diamond having the NEA characteristics, by contrast, the NEA does not have an influence on the hot electron emission even if the NEA slightly fluctuates, as long as the electron affinity is negative. It is the energy difference (Ed) between the donor level and the bottom of the conduction band (Ec) that determines the hot electron emission. The energy difference (Ed) corresponds to not a surface property but a property of a bulk determined by the dopant. Therefore, by using the n-type diamond, the uniform hot electron emission in the electron emission surface is expected. Besides, the diamond is a substance having the highest heat conductivity. Due to this, even if the diamond is heated by Joule heat, inflow of ions and electrons, or impact, a heat is promptly conducted to surroundings, thereby making temperature uniform. While a sufficient effect can be attained by using the n-type diamond, the effect is greater when a uniformly continuous film is formed by the n-type diamond.

An example of a method of manufacturing the hot cathode and the discharge lamp according to the eighth embodiment will be explained. A filament formed by coiling a tungsten wire at a diameter of 30 micrometers is prepared. This filament treatment is the same as that according to the fourth embodiment. A polycrystalline diamond layer at a thickness of about 5 micrometers is formed on this filament by, for example, the microwave plasma CVD method. Polycrystalline diamond layer growth conditions are as follows. A microwave power is 4 kilowatts, a hydrogen flow rate is 200 sccm, a methane gas flow rate is 4 sccm, and a methane concentration of a material gas is 2%. In addition, a material gas pressure is 13.3 kilopascals, a film formation temperature is 850 degrees, and a film formation time is 120 minutes. Under these conditions, phosphorus is used as the n-type dopant, and a phosphine gas is also supplied during growth of diamond. A ratio of the phosphine gas to the methane gas is set at 1,000 parts per million.

Thereafter, a lead wire is provided at the filament to support the filament, a fitting is attached to the lead wire, the resultant filament is attached to a glass tube, and a discharge gas is filled into the glass tube. The discharge lamp is thus completed.

The eighth embodiment can exhibit the same advantages as those of the fourth embodiment by providing the member consisting of the hydrogen absorbing alloy in the discharge tube.

FIG. 11 is a cross-sectional view of a cathode used in a discharge lamp according to a ninth embodiment of the present invention. As shown in FIG. 11, a hydrogen absorbing alloy film 82 consisting of a hydrogen absorbing alloy, e.g., Mg₂Ni and having a thickness of 0.5 micrometer is formed on a surface of a cathode supporting member 81 consisting of a metal such as nickel. A diamond layer 83 consisting of polycrystalline diamond and having a thickness of 2 micrometers is formed on a surface of the hydrogen absorbing alloy film 82. This diamond layer 83 consists of crystal grains at an average grain diameter of 0.2 micrometer, and grain boundaries 84 present in the diamond layer 83 range from the surface of the hydrogen absorbing alloy film 82 to an outside (a surface of the diamond layer 83, i.e., a discharge space of the discharge lamp).

This cathode is used as a cathode of the discharge lamp. If so, when the partial pressure of a hydrogen gas within a discharge tube is reduced, then hydrogen is dissociated from the hydrogen absorbing alloy film 82, the dissociated hydrogen is emitted into the discharge space of the discharge lamp via the grain boundaries 84 in the diamond layer 83 consisting of polycrystalline diamond. The partial pressure of the hydrogen gas can be thereby kept at optimum level.

If the cathode according to the ninth embodiment is used as, for example, the cathode according to the seventh embodiment (without the hydrogen absorbing alloy member 136), the hydrogen dissociation pressure of the Mg₂Ni alloy gradually rises following an increase in the internal temperature of the glass tube 130, and reaches about 35 pascals at 80 degrees. The dissociated hydrogen is emitted from the hydrogen absorbing alloy film 82 via the grain boundaries 84 in the diamond layer 83, thereby keeping the partial pressure of the hydrogen gas within the tube of the discharge lamp at 35 pascals. In this state, even if an amount of the hydrogen gas is reduced in the glass tube 130, hydrogen is emitted from the hydrogen absorbing alloy so as to maintain the dissociation pressure.

An example of a method of manufacturing the cathode according to the ninth embodiment will be explained. The cathode supporting member 81 consisting of molybdenum is prepared, and the hydrogen absorbing alloy film 82 is formed on the surface of the cathode supporting member 81. The hydrogen absorbing alloy film 82 can be formed by oblique sputtering or oblique evaporation as explained. A diamond seeds planting is performed on the hydrogen absorbing alloy film 82. This diamond seeds planting is performed similarly to the fourth embodiment. The cathode supporting member 81 including the hydrogen absorbing alloy film 82 that has been subjected to the diamond seeds planting is moved into the microwave plasma CVD system shown in FIG. 3. In the microwave-plasma CVD system, the diamond layer 83 consisting of polycrystalline diamond is formed on the surface of the hydrogen absorbing alloy film 82. Film formation conditions are as follows. A microwave power is 2 kilowatts, a material gas pressure is 10 kilopascals, a hydrogen gas flow rate is 300 sccm, a methane gas flow rate is 6 sccm, a methane concentration of a material gas is 2%, a film formation temperature is 750 degrees, and a film formation time is 150 minutes. Under these conditions, the polycrystalline diamond layer 83 having a thickness of 2 micrometers and consisting of crystal grains at the average diameter of 0.2 micrometer is formed.

In this example, only the hydrogen gas and the methane gas are used to form the polycrystalline diamond layer 83. Alternatively, the polycrystalline diamond layer 83 may be formed by doping impurities. In addition, the polycrystalline diamond layer 83 may be formed by the ECRCVD method or the radio frequency CVD method instead of the microwave plasma CVD method.

In order to ensure emitting hydrogen via the grain boundaries 84 present in the polycrystalline diamond layer 83, the polycrystalline diamond layer 83 preferably has a thickness not less than 1 micrometer and not more than 5 micrometers, and an average grain diameter not less than 0.1 micrometer and not more than 0.5 micrometer.

Furthermore, the cathode shown in FIG. 11 can be applied to the hot cathode. It is, however, preferable to particularly apply the cathode shown in FIG. 11 to the cold cathode (including that in the external electrode discharge lamp) for the following reasons. If the cathode is used as the hot cathode and the hydrogen absorbing alloy is heated extremely by the filament or the like, then the dissociation pressure of the hydrogen absorbing alloy suddenly rises, depending on an application, utilization conditions, or the like of the discharge lamp. This often results in deterioration in the discharge characteristics of the discharge lamp, that is, deterioration in the performance of the discharge lamp. Further, if the dissociation pressure of the hydrogen absorbing alloy suddenly rises, then hydrogen absorbing characteristics of the hydrogen absorbing alloy is often deteriorated, and a tolerance of the discharge lamp is often deteriorated.

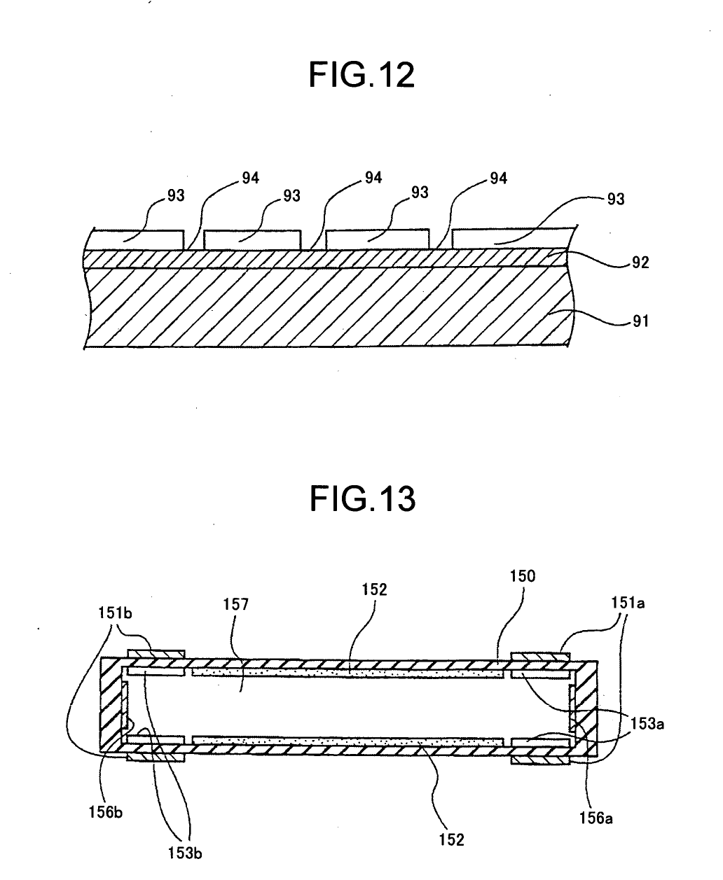

FIG. 12 is a cross-sectional view of a cathode used in a discharge lamp according to a tenth embodiment. As shown in FIG. 12, a hydrogen absorbing alloy film 92 consisting of a hydrogen absorbing alloy, e.g., Mg₂Ni and having a thickness of 0.5 micrometer is formed on a surface of a cathode supporting member 91 consisting of a metal such as nickel. A diamond layer 93 at a thickness of 2 micrometers is formed on a surface of the hydrogen absorbing alloy film 92. The diamond layer 93 has a predetermined pattern (e.g., a stripe pattern or an island pattern), the hydrogen absorbing alloy film 92 is exposed from pattern unformed parts 94. The diamond layer 93 consists of crystal grains at an average grain diameter of 0.2 micrometers, and grain boundaries present in the diamond layer 93 range from the surface of the hydrogen absorbing alloy film 92 to an outside (a discharge space of the discharge lamp).

When a partial pressure of a hydrogen gas within a discharge tube is reduced, then hydrogen is dissociated from the hydrogen absorbing film 92, and the dissociated hydrogen is emitted into the discharge space of the discharge lamp via the grain boundaries in the diamond layers as well as the pattern unformed parts 94. The partial pressure of the hydrogen gas can be thereby kept at appropriate level.

Therefore, the cathode according to the tenth embodiment can exhibit the same functions and advantages as those according to the ninth embodiment. A method of manufacturing the cathode according to the tenth embodiment is the same as the example of the method explained in the ninth embodiment except that the diamond layer 93 consists of monocrystalline diamond and that is processed into the predetermined pattern by well-known photolithographic and etching techniques. As an etch gas, a mixture gas of CF₄ and O₂ is used. The pattern and the pattern unformed parts 94 of the diamond layer 93 are thus formed.

According to the tenth embodiment, only the hydrogen gas and the methane gas are used to form the polycrystalline diamond layer 83. Alternatively, the diamond layer 83 may be formed by doping impurities to the polycrystalline diamond layer 83, similarly to the fourth embodiment. In addition, the polycrystalline diamond layer 83 may be formed by the other method such as the ECRCVD method or the radio frequency CVD method instead of the microwave plasma CVD method.

If a polycrystalline diamond layer is used as the diamond layer 93, the method according to the ninth embodiment can be used as the diamond thin film forming method. If so, in order to ensure emitting hydrogen via the grain boundaries in the diamond layer 93, the diamond layer 93 preferably has a thickness not less than 1 micrometer and not more than 5 micrometers, and an average grain diameter not less than 0.1 micrometer and not more than 0.5 micrometer.

Furthermore, the cathode shown in FIG. 12 can be applied to the hot cathode. It is, however, preferable to particularly apply the cathode shown in FIG. 12 to the cold cathode (including that in the external electrode discharge lamp) for the same reasons as those explained in the ninth embodiment.

FIG. 13 is a cross-sectional view of an external electrode discharge lamp according to an eleventh embodiment of the present invention. This external electrode discharge lamp has electrodes provided on an outer surface of a discharge tube. By applying a voltage between the electrodes, discharge is induced within the discharge tube to thereby emit a light.

As shown in FIG. 13, the discharge lamp according to the eleventh embodiment includes a glass tube 150, a phosphor 152, which is formed on an inner surface of the glass tube 150, and which generates a visible light when being irradiated with ultraviolet rays, pairs of cylindrical diamond layers 153a and 153b attached to inner surfaces of both ends of the glass tube 150, respectively, and pairs of external electrodes 151a and 151b attached to outer surfaces of the both ends of the glass tube 150 via the glass tube 150 relative to the paired diamond layers 153a and 153b, respectively. The paired external electrodes 151a and 151b consist of, for example, tungsten (W) or molybdenum (Mo).

A discharge gas 157 is filled into an interior of the glass tube 150. The discharge gas 157 consists of a rare gas (e.g., Ar, Ne, or Xe) or a mixture rare gas of Ar, Ne, and Xe, a trace amount of mercury, and a hydrogen gas. In addition, hydrogen absorbing alloy films 156a and 156b are provided on the inner surfaces of the both ends of the glass tube 150, respectively, so as to keep a partial pressure of the hydrogen gas within the glass tube 150 at appropriate level.

A temperature of a discharge region between the diamond layers 153a and 153b within the glass tube 150 is remarkably high. It is, therefore, preferable to provide the hydrogen absorbing alloy films 156a and 156b at positions near the ends of the glass tube 150 relative to the diamond layers 153a and 153b, respectively. Alternatively, the hydrogen absorbing alloy members 156a and 156b may be put closer to a center of the glass tube 150, according to the temperature, a position, and the like of the discharge region.

An operation of this external electrode discharge lamp will be explained. In order to start discharge, a high-frequency voltage of 1,000 volts with a frequency of 40 kilohertz is applied between a pair of external electrodes 151a and 151b. Steps of emitting electrons from the diamond layer 153a (or 153b) and starting the discharge are the same as those for the discharge lamp according to the fourth embodiment. In addition, functions and advantages of the hydrogen absorbing alloy films 156a and 156b are the same as those according to the fifth embodiment. With this mechanism, discharge occurs intermittently, and the phosphor 152 is excited by ultraviolet rays generated by the discharge, thereby emitting a light.

In the external electrode discharge lamp, the external electrodes 151a and 151b are not exposed to the discharge space. Due to this, it is unnecessary to contain mercury in the glass tube 150 so as to suppress consumption of the external electrodes 151a and 151b. Therefore, only the hydrogen gas and the rare gas can be used as gas filled into the glass tube 150.

An example of a method of manufacturing this external electrode discharge lamp will be explained. The glass tube 150 is prepared, and a mask or the like is formed in portions on the inner surface of the glass tube 150 in which the diamond layers 153a and 153b are not to be formed. A diamond seeds planting is performed on portions on the inner surface of the glass tube 150 in which the diamond layers 153a and 153b are to be formed (cylindrical regions on the inner surfaces of the both ends of the glass tube 150) similarly to the fourth embodiment. After removing the mask or the like, the film forming method such as the microwave plasma CVD method is used similarly to the respective preceding embodiments, whereby the diamond layers 153a and 153b are selectively formed in the portions on the inner surface of the glass tube 150 which have been subjected to the diamond seeds planting. As a result of this film forming step, the cylindrical diamond layers 153a and 153b are formed only on the inner surfaces of the both ends of the glass tube 150. Since the diamond layers 153a and 153b are not conductive, it is unnecessary to dope the diamond layers 153a and 153b with a p-type dopant or an n-type dopant.

The hydrogen absorbing alloy films 156a and 156b are formed at positions near the ends of the glass tube 150 relative to the diamond layers 153a and 153b, respectively. The phosphor 152 is coated and formed on the inner surface of the glass tube 150. The phosphor 152 is not formed on the inner surfaces of the both ends of the glass tube 150 on which the diamond layers 153a and 153b are provided, by using the mask or the like.

The discharge gas is filled into the glass tube 150, and the glass tube 150 is sealed by sealing parts provided on both ends of the glass tube 150. For example, by heat-treating the sealing parts on the both ends of the glass tube 150 at a temperature of 750 degrees, the sealing parts are softened and fluidized, whereby the glass tube 150 can be sealed. Finally, the external electrodes 151a and 151b are formed on the both ends of the outer surface of the glass tube 150. The discharge lamp according to the eleventh embodiment is thus completed.

According to the embodiments, the types of the hydrogen absorbing alloy are not limited to the CeMg₂ alloy and Mg₂Ni alloy. An arbitrary hydrogen absorbing alloy which has characteristics that satisfy the requirement for the partial pressure of the hydrogen gas within the discharge tube may be used. The shape of the hydrogen absorbing alloy member may be a plate, a rod, a needle, or the like other than the pellet or the film. The member including the hydrogen absorbing alloy may be a member consisting only of the hydrogen absorbing alloy or a combination of the member consisting only of the hydrogen absorbing alloy and a member consisting of a material other than the hydrogen absorbing alloy. The member consisting of the other material is, for example, a member for fixing the hydrogen absorbing alloy member to the inner wall of the discharge tube or a constituent member of the phosphor.

In the embodiments explained so far, an outer envelope of the discharge lamp is not limited to the glass tube but may be an envelope which enables the discharge lamp to discharge current within the outer envelope, and which can extract a light from inside to outside. The shape of the outer envelope of the discharge lamp may be a flat plate, a curved plate, a sphere, or the like as well as a tube. The electrode material is not limited to tungsten or molybdenum but may be the other material such as tantalum. The shape of the electrode may be, for example, a rod or a line, besides those explained above.

In the external electrode discharge lamp, the phosphor and each diamond member may be provided so that, for example, the diamond member is superposed on the fluorescent film. Namely, the fluorescent film may be provided on an inner surface of the outer envelope, and the diamond member may be provided on the fluorescent film.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A discharge lamp comprising:
an outer envelope filled with a discharge gas;
a fluorescent film provided on an inner surface of the outer envelope;
electrodes provided within the outer envelope, and causing electric discharge to occur within the outer envelope; and
a diamond member provided on a surface of each of the electrodes, wherein oxygen is contained in the discharge gas at a ratio not less than 0.002% and not more than 12.5%.

2. The discharge lamp according to claim 1, wherein the oxygen suppresses adhesion of a carbon layer containing a non-diamond component to a surface of the diamond member.

3. The discharge lamp according to claim 1, wherein the diamond member is a diamond film which covers at least a part of the surface of each of the electrodes.

4. The discharge lamp according to claim 1, wherein the diamond member comprises diamond which contains donor impurities.

5. The discharge lamp according to claim 1, wherein the discharge gas contains an element having a main light emitting peak not more than 200 nanometers.

6. The discharge lamp according to claim 1, wherein the discharge gas contains a rare gas and mercury.

7. The discharge lamp according to claim 1, wherein the discharge gas contains xenon.

8. The discharge lamp according to claim 1, wherein the discharge gas contains a hydrogen gas.

9. A discharge lamp comprising:
an outer envelope filled with a discharge gas;
a fluorescent film provided on an inner surface of the outer envelope;
electrodes provided on an outer surface of the outer envelope, and causing electric discharge to occur within the outer envelope; and
a diamond member provided on an inner surface of the outer envelope to be opposed to each of the electrodes, wherein oxygen is contained in the discharge gas at a ratio not less than 0.0020% and not more than 12.5%.

10. The discharge-lamp according to claim 9, wherein the diamond member is a diamond film which covers at least a part of the surface of each of the electrodes.

11. The discharge lamp according to claim 9, wherein the discharge gas contains an element having a main light emitting peak not more than 200 nanometers.

12. The discharge lamp according to claim 9, wherein the discharge gas contains a rare gas and mercury.

13. The discharge lamp according to claim 9, wherein the discharge gas contains xenon.

14. The discharge lamp according to claim 9, wherein the discharge gas contains a hydrogen gas.

15. A discharge lamp comprising:
an outer envelope filled with a discharge gas;
a fluorescent film provided on an inner surface of the outer envelope;
electrodes provided within the outer envelope, and causing electric discharge to occur within the outer envelope;
a diamond member provided on a surface of each of the electrodes; and
a member containing a hydrogen absorbing alloy, and provided within the outer envelope.

16. The discharge lamp according to claim 15, wherein the discharge gas contains a hydrogen gas.

17. The discharge lamp according to claim 15, wherein the member containing the hydrogen absorbing alloy is provided around the diamond member.

18. The discharge lamp according to claim 15, wherein the member containing the hydrogen absorbing alloy is a film provided on the inner surface of the outer envelope.

19. The discharge lamp according to claim 15, wherein
the member containing the hydrogen absorbing alloy is provided between the diamond member and each of the electrodes.

20. The discharge lamp according to claim 19, wherein the diamond member covers a part of a surface of the member containing the hydrogen absorbing alloy, and exposes other parts of the surface.

21. The discharge lamp according to claim 15, wherein the member containing the hydrogen absorbing alloy has a polycrystalline crystal state.

22. A discharge lamp comprising:
an outer envelope filled with a discharge gas;
a fluorescent film provided on an inner surface of the outer envelope;
electrodes provided on an outer surface of the outer envelope, and causing electric discharge to occur within the outer envelope;
a diamond member provided on the inner surface of the outer envelope to be opposed to each of the electrodes; and
a member containing a hydrogen absorbing alloy, and provided within the outer envelope.

23. The discharge lamp according to claim 22, wherein the discharge gas contains a hydrogen gas.
